(19) United States
(12) Patent Application Publication
(10) Pub. No.: US 2007/0011234 A1
(43) Pub. Date: Jan. 11, 2007

(54) Computer conferencing system and features

(75) Inventor: Mark R. Albrecht, Hanover, MA (US)

Correspondence Address: MIELE LAW GROUP, 2 SUMMER STREET, SUITE 306, NATICK, MA, 01760, US

(73) Assignee: XCM Development, LLC, Braintree, MA (US)

(21) Appl. No.: 11/193,293

(22) Filed: Jul. 29, 2005

Related U.S. Application Data
(60) Provisional application No. 60/592,036, filed on Jul. 29, 2004.

(51) Int. Cl. G06F 15/16

(52) U.S. Cl. 709/204

(57) ABSTRACT

Computer conferencing apparatus are provided. A conferencing session intake interface is provided to receive, at a computer, parameters defining plural conferencing sessions. A computer screen provider is provided to provide at computers, participant screens which include a first screen for a first participant and a second screen for a second participant. The first screen provides the first participant with computer screen access to a representation of all sessions contemporaneously located with the first participant, and provides the first participant with computer screen access to information indicating a present phase of each of the sessions contemporaneously located with the first participant. The second screen provides the second participant with computer screen access to a representation of all sessions contemporaneously located with the second participant, and provides the same participant with computer screen access to information indicating a present phase of the sessions contemporaneously located with the second participant. A phase change intake interface is provided to receive, at a computer screen interface, phase change information for a given session. A location intake interface is provided to receive, at a computer screen interface, location change information changing a present location of the given session.

### RELATED APPLICATION DATA

Priority is hereby claimed to U.S. Provisional Application No. 60/592,036 filed Jul. 29, 2004, in the name of Mark R. Albrecht, and the content of this Provisional Application is hereby incorporated herein by reference in its entirety.

### NOTICE OF COPYRIGHT

This patent document contains information subject to copyright protection. The copyright owner has no objection to the facsimile reproduction by anyone of the patent document or the patent, as it appears in the U.S. Patent and Trademark Office files, but otherwise reserves all copyright rights whatsoever.

### BACKGROUND

The present disclosure relates to systems and processes for facilitating communication among participants of a process, for example, in the providing of services.

Various types of systems exist that facilitate communication among different personnel. For example, e-mail software systems are typically used by workers to communicate with each other. In addition, workers can post documents to a document management system or to an intranet as a way to communicate with one another. Databases are also used to allow personnel to categorize, store, and exchange various types of information.

### SUMMARY

Computer conferencing apparatus are provided in one embodiment. A conferencing session intake interface is provided to receive, at a computer, parameters defining plural conferencing sessions. A computer screen provider is provided to provide, at computers, participant screens which include a first screen for a first participant and a second screen for a second participant.

The first screen provides the first participant with computer screen access to a representation of all sessions contemporaneously located with the first participant, and provides the first participant with computer screen access to information indicating a present phase of each of the sessions contemporaneously located with the first participant. The second screen provides the second participant with computer screen access to a representation of all sessions contemporaneously located with the second participant, and provides the same participant with computer screen access to information indicating a present phase of the sessions contemporaneously located with the second participant.

A phase change intake interface is provided to receive, at a computer screen interface, phase change information for a given session. A location intake interface is provided to receive, at a computer screen interface, location change information changing a present location of the given session.

### BRIEF DESCRIPTION OF THE DRAWINGS

Embodiments of the present disclosure are further described in the detailed description which follows, by reference to the noted drawings by way of non-limiting exemplary embodiments, in which like reference numerals represent similar parts throughout the several views of the drawings, and wherein:

FIG. 1 is a block diagram of a service provider networked system;

FIG. 2 is a block diagram illustrating the interaction between clients and various entities utilizing the service provider networked system shown in FIG. 1;

FIG. 3 is a flow chart of a general process performed by the conferencing session software shown in FIG. 1;

FIG. 4 is a block diagram illustrating example home pages for various participants communicating during a session using the illustrated conferencing session software;

FIG. 5 is a block diagram of the data management architecture of the illustrated conferencing system;

FIG. 6 is a schematic block diagram of a computer interface 119 for a given participant, viewing his or her screen;

FIG. 7 is a schematic diagram of an email notification interface;

FIG. 8 shows an example of a participant screen;

FIG. 9 is another participant screen;

FIG. 10 shows an example profile sheet screen;

FIG. 11 shows an example of a Move Tax Return screen; and

FIG. 12 shows an example of a question form screen.

### DETAILED DESCRIPTION

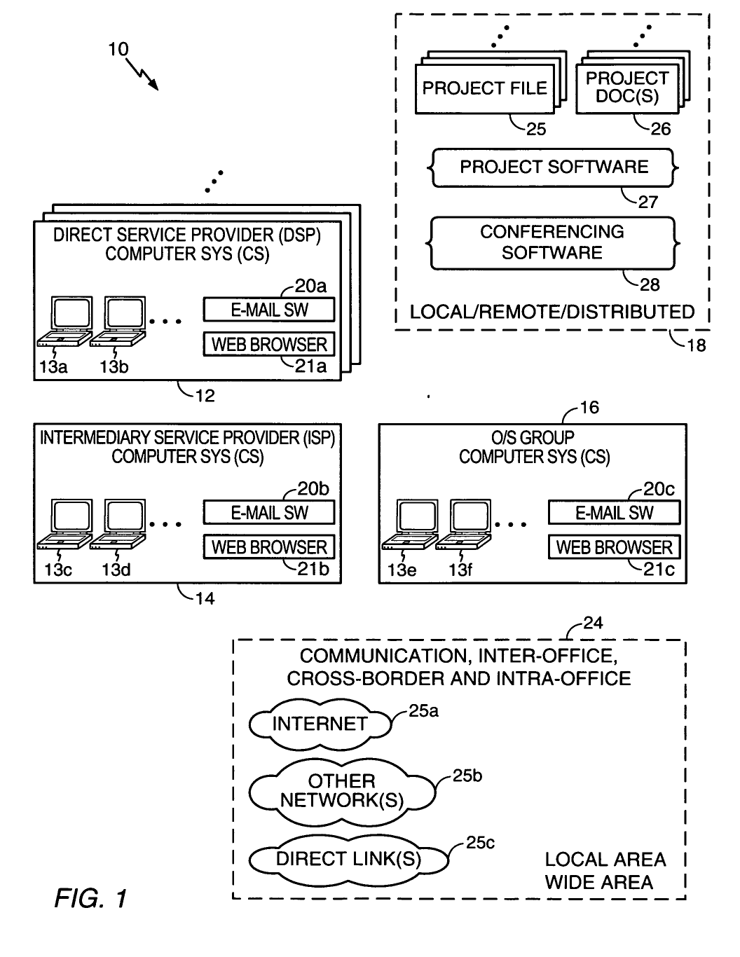

Referring now to the drawings in greater detail, FIG. 1 is a block diagram of a service provider networked system 10. The various computer systems shown in FIG. 1 may all be provided to serve ultimate clients (not shown in FIG. 1). For example, a number of direct service provider computer systems 12 may be provided, which communicate with ultimate clients, for example, in the preparation of tax returns, in the provision of bookkeeping services, or in carrying out other financial services on behalf of such ultimate clients. An intermediary service provider computer system 14 may be provided, which is in communication with the plural direct service provider computer systems 12. Intermediary service provider computer system 14 may perform certain parts of the services for which ultimate clients have retained the direct service providers. Intermediary service provider computer system 14 may provider other services, including facilitating conferencing among various participants of a given process, for example, a process required to complete a specific project. More specifically, either the direct service provider computer systems 12 or the intermediary service provider computer system 14 may have software that allows participants, i.e., personnel within the organization, to carry out a project and to communicate via a conferencing session regarding the projects.

The illustrated system 10 includes software and data 18. The illustrated software and data 18 includes plural project files 25 corresponding to projects being performed on behalf of ultimate clients and corresponding project documents 26. The software and data 18 further includes project software 27. For example, if financial services projects are being performed on behalf of ultimate clients, the project software may include financial services software, for example, bookkeeping software or software to help in the preparation of individual tax returns. The illustrated software and data 18 further includes conferencing software 28. Any of the components of software and data 18 may be local or remote to one or all of the illustrated computer systems 12, 14, and 16.

The illustrated system 10 further includes an outsourcing group computer system 16. Direct service provider computer systems 12 each include individual participant computers 13a, 13b (and others not specifically shown), e-mail software 20a, and a web browser 21a. Similarly, intermediary service provider computer system 14 includes a plurality of participant computers 13c, 13d (and others optionally also provided but not specifically shown). The intermediary service provider computer system 14 may be further provided with e-mail software 20b and web browser software 21b. Outsourcing group computer system 16 may also have a plurality of participant computers 13e, 13f (and optionally others), e-mail software 20c, and web browser software 21c.

The e-mail software and the web browser for each of these systems may include software running on the individual participant computer workstation; they may each include software executed by distributed processing among different computer systems; or they may each include software executed at a server computer and a client component.

Each of the computer systems illustrated in FIG. 1 may communicate via a communications infrastructure 24. Accordingly, communication may be inter-office, across borders of different countries, and/or within a given office. Such a communications infrastructure 24 may include, for example, one or more of the Internet 25a, other networks 25b, and direct links 25c. Any portion of the communications infrastructure 24 may involve a local area network or a wide area network.

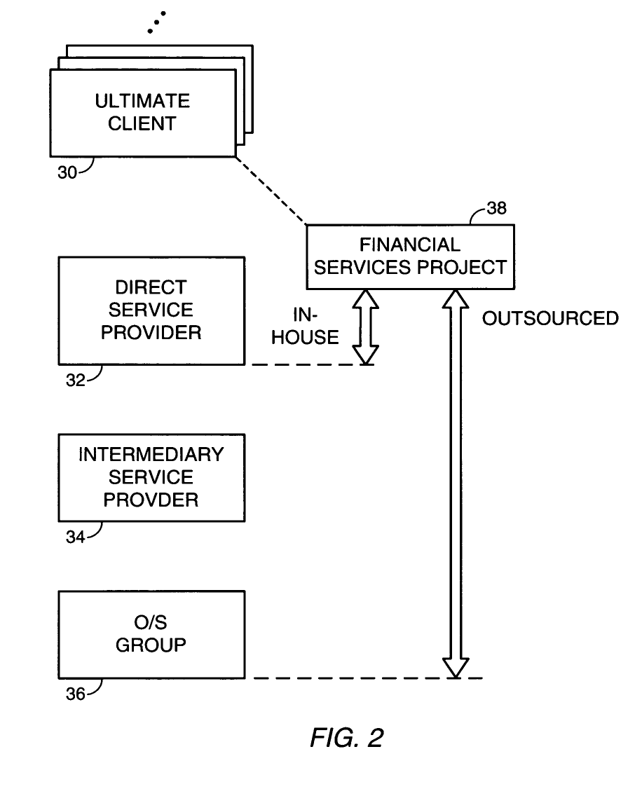

As shown in FIG. 2, ultimate clients 30 may require the services of direct service providers 32, for example, in the carrying out of a certain project. In the illustrated embodiment, the project is a financial services project 38. A given project may be performed in-house, or the project may be outsourced. If the project is performed in-house, the direct service provider 32 handles the project. If the project is outsourced, the project may be outsourced to an outsourcing group 36. An intermediary service provider 34 may act as a go-between between the direct service provider 32 and the outsourcing group 36.

By way of example, for a given financial services project 38, for example, the preparation of a given tax return for an ultimate client 30, direct service provider 32, which may be an accounting firm, receives the project and processes it. A decision is made as to whether the project is to be performed in-house, or whether it is to be outsourced. With either of these options, the complete project can be tracked using a computer system running the conferencing software 28 shown in FIG. 1 (a conferencing system). By utilizing such a conferencing system, the various participants carrying out the project can better manage the work load associated with each project.

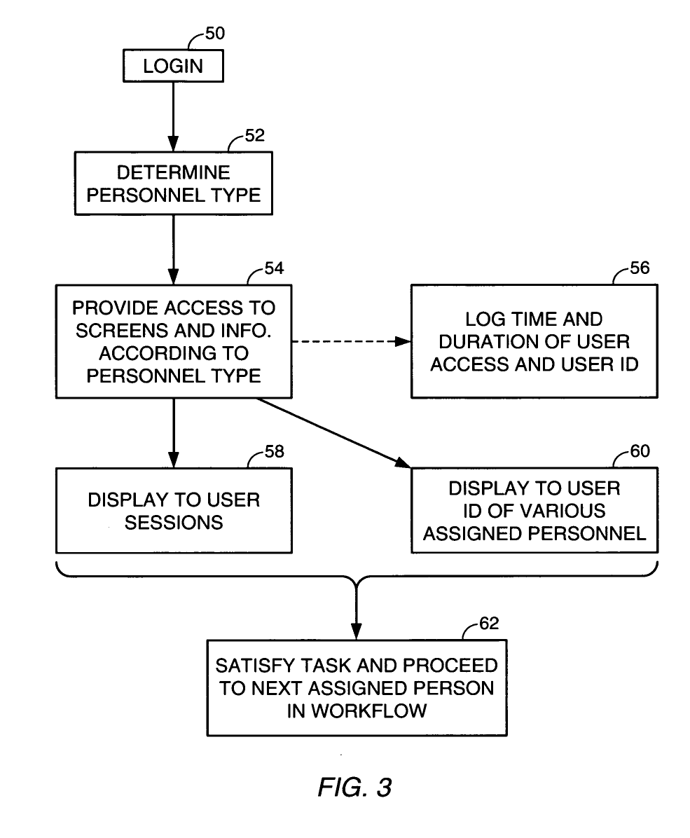

To facilitate workflow, the conferencing system may carry out a conferencing and status tracing process, for example, as shown generally by the flow chart shown in FIG. 3. In this process, each person responsible for a given part of the processing of a given project (a participant) will access a web page which is provided by the conferencing system. As shown in FIG. 3, in a first act 50, the user (a participant which includes a given one of the various types of personnel involved in the overall process) will log into the conferencing system. In act 52, a determination is made as to the participant's category (personnel type), for example, whether the user is an administrative person, review personnel, staff personnel, delivery personnel, and/or a partner/client contact. In the next act 54, participants are given access to certain screens and information according to their participant category. As shown in act 56, whenever a given user accesses the session conferencing system, certain information is logged or stored which pertains to that given user. Specifically, in the embodiment shown, the times at which the user accesses the system and the duration of each such access are stored in connection with the user ID.

In act 58, certain tasks that are assigned to the user may then be displayed to the user. In order to do this, these sessions located with the user are displayed to the user, and those sessions may be organized by session phase, i.e., the current phase of each session. Accordingly, a participant participating in a conferencing session will know that it has a role in a specific phase of a conferencing session by looking at the displayed session phase of those sessions that have been moved to that participant, i.e., that are located with that participant. In embodiments disclosed herein, when a given session is “located” with a given participant, the given participant and other participant will be provided with indications (e.g., on their respective conferencing session web pages) that the given session is in the “court” of the given participant.

To help the participant prioritize his or her schedule, the participant is able to view all those sessions located with him or her. For example, if a tax return preparation project is involved, a given phase of the session may be “In House Preparation” of the tax return by a tax staff participant. If the participant is a tax staff member, for example, of a direct service provider accounting firm, or of an outsourcing group, that participant will know to prepare the tax return because the session will have been specifically located with that participant and its phase will indicate that the tax return's status is “In House Preparation.”

In act 60 the process further displays to the user the identification of various personnel (participants) that have also been assigned to the same session. Finally, in act 62, once the task associated with the present phase of the current session is satisfied, the participant may interact with the conferencing session system and relocate the session with another participant to carry out a next task in the work flow for the project being carried out in connection with the session. The participant relocates the session, e.g., by providing information through the user's web page or by checking a box provided on the web page.

By way of example, in the case of a tax return preparation, if the work flow dictates that upon preparation of a draft return the supervisor should review the draft return, the web page of the corresponding supervisor for that tax return should now reflect that he or she is to review the draft return. In the illustrated conferencing system, the correct relocation of a given a session for the tax return to the next participant in the work flow process depends upon the participant correctly relocating the session to the appropriate next participant. When the session has been correctly relocated, when next participant in the work flow logs onto his or her web page, he or she will find the session (corresponding to the tax return) on his or her web page for review.

The conferencing system may be configured to pull information from a specified source into its database, to populate all the information it requires for a given session. That information may include an indication of whether a given project is to be outsourced or is to be prepared in-house. In addition, or alternatively, information may be input directly via a conferencing system web page.

An administrative home page (not shown) may be provided, through which administration staff may input certain profile data for a number of sessions. The administrator may scan and submit documentation corresponding to projects to a hosting system, and indicate the completion of this task through the conferencing system, at which point the conferencing system will move the session corresponding to the given tax return to the staff participant to which the session has been assigned, based upon information previously provided.

Should the project be an outsourced tax return, the outsourcing supervisor will find the tax return and its identifying information on his or her home page through the conferencing system. The outsourcing supervisor then reviews the information and assigns the tax return to an individual staff person within the outsourcing group. At that point in time, the individual tax staff person within the outsourcing group will find that tax return on his or her conferencing session home page.

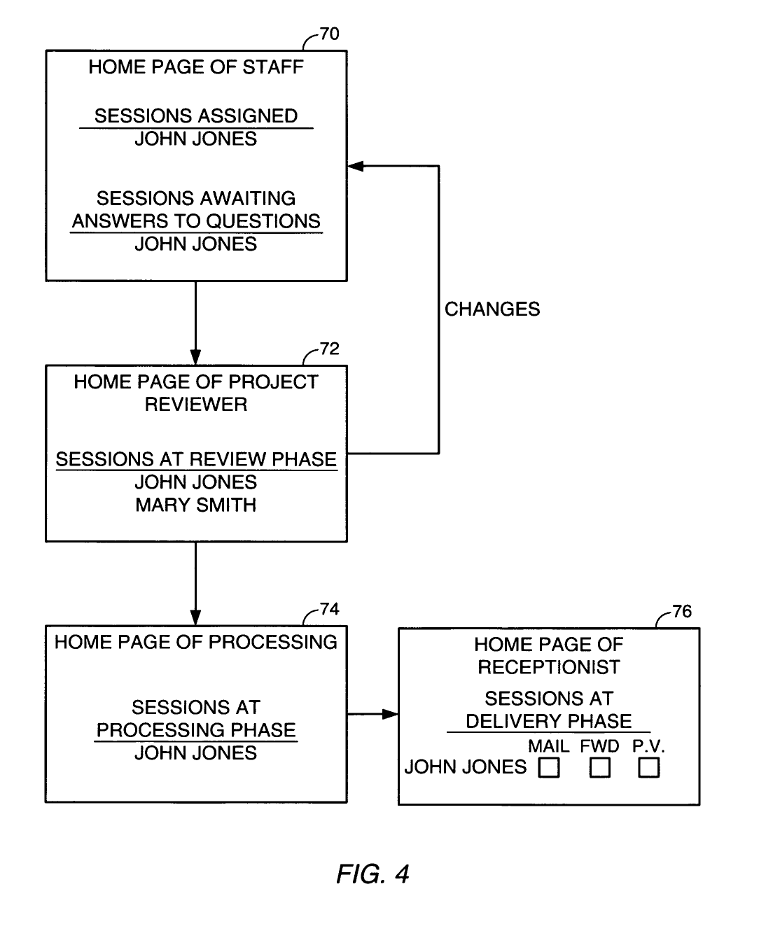

FIG. 4 provides examples of home pages for tax staff 70, a project reviewer 72, a processing department 74, and a receptionist 76.

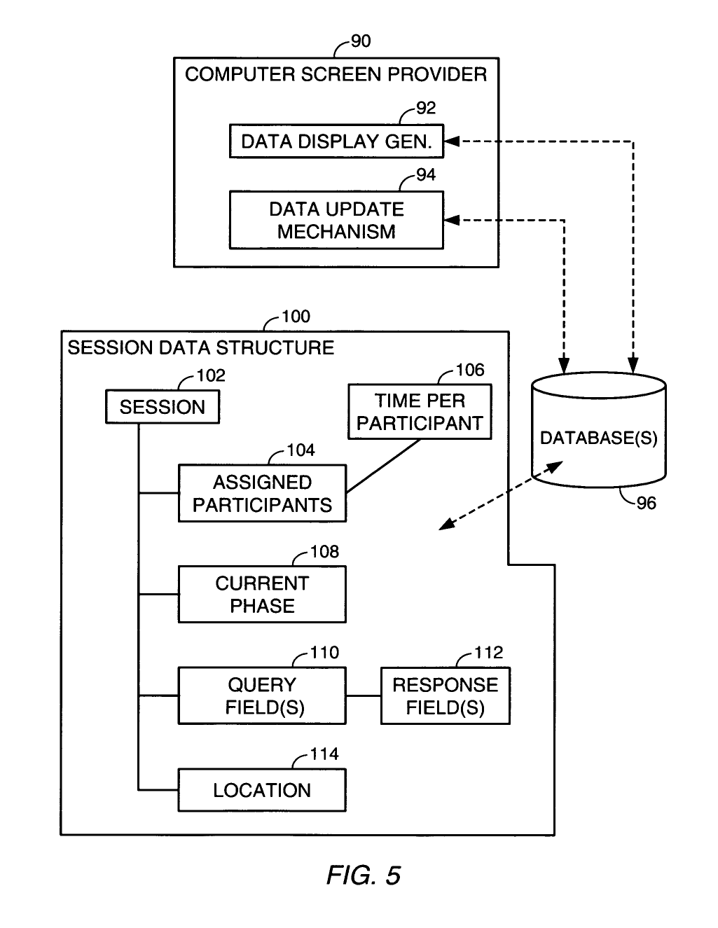

FIG. 5 is a block diagram of the data management architecture of the illustrated conferencing system. As shown in FIG. 5, a computer screen provider 90 is provided, which includes a data display generator 92 and a data update mechanism 94. In addition, one or more databases 96 are provided. Data is stored within the one or more databases 96, and such data includes a session data structure 100 for each conferencing session managed by the conferencing system. A session data structure 100 includes a session field 102. Associated with that session field 102 are other fields including an assigned participants field 104, a current phase field 108, one or more query fields 110, and a location field 114. For each assigned participant, one or more records or fields 106 may be provided for keeping track of the times each participant is accessing the system as well as the accumulated time a participant is accessing the system for a particular session. For each query field 110, a corresponding response field 112 may be provided.

The data display generator 92 interacts with data stored in database(s) 96 to display the same on the participant screens and other interfaces of the conferencing system. Data update mechanism 94 updates the corresponding fields and the data structures within database(s) 96 in response to changes to data made via computer screens of the conferencing system, and updates the data displayed on those computer screens in accordance with any changes to the same.

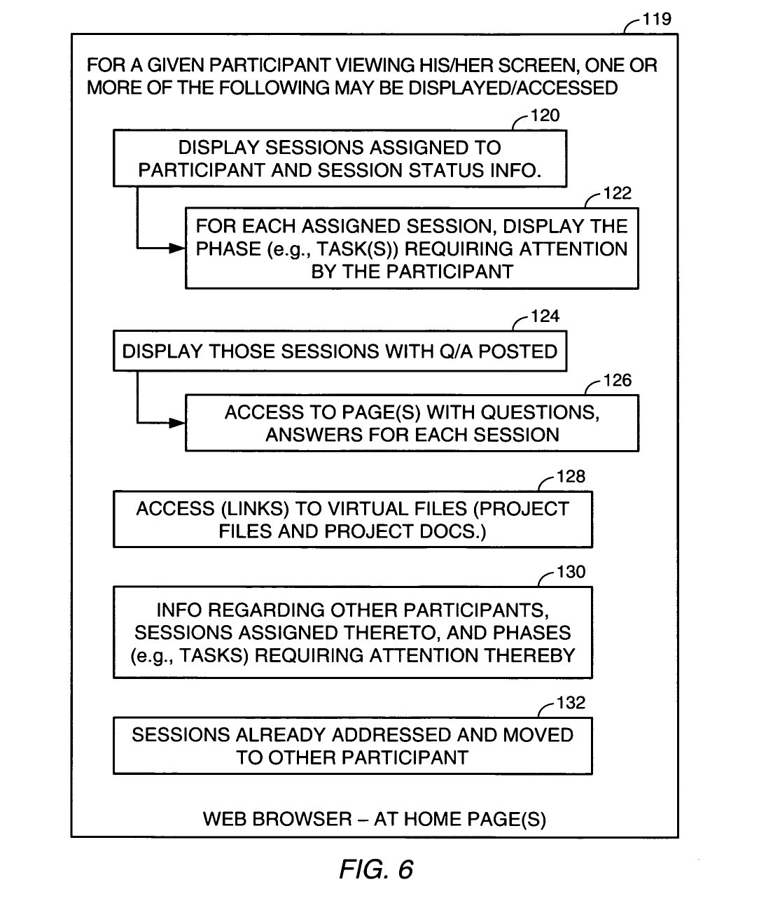

FIG. 6 is a schematic block diagram of a computer interface 119 for a given participant, viewing his or her screen. As shown in FIG. 6, when a given participant is viewing his or her screen, one or more types of information may be displayed or accessed by the participant via graphical tools schematically portrayed by text boxes. In the illustrated embodiment, the screen includes one or more home pages accessed via a web browser.

As shown in FIG. 6, the illustrated interface 119 includes a session tool 120 to display or provide access to sessions and session status information for each session assigned to (located with) the given participant. A phase tool 122 displays or provides access to the phase of each session. A posted Q/A tool 124 displays or provides access to those sessions for which questions or answers have been posted. For each such session, a Q/A tool 126 provides the participant with access to one or more pages displaying the questions or answers.

Through a virtual files tool 128, the participant has access to virtual files. Such access may include URL links to those files. Those files may include, for example, project files and project documents.

Another participant tool 130 may be provided, through which the participant may see information regarding other participants, sessions assigned to those participants, and phases of those sessions requiring attention by those participants. A move session tool 132 may be provided to indicate the sessions already addressed by the participant and moved to other participants.

Each of the tools shown in the interface 119 of FIG. 6 may include icons or otherwise manipulable graphical tools to display or allow access to, or to change, information. A graphical tool may include, for example, an icon or button that can be activated by clicking a mouse with a curser situated over the icon or button. A graphical tool may include a form or textual input represented on a computer screen. A graphical tool may include a menu of displayed symbols or text that could be chosen by pointing to and clicking over a given symbol or text. The graphical tool can also include a drop-down menu, or any other type of graphical tool. Alternatively, other tools may be provided to allow a user to control and operate, or simply to view, any of the functions or information referred to in the interface shown in FIG. 6, for example, with the use of a command-line type interface.

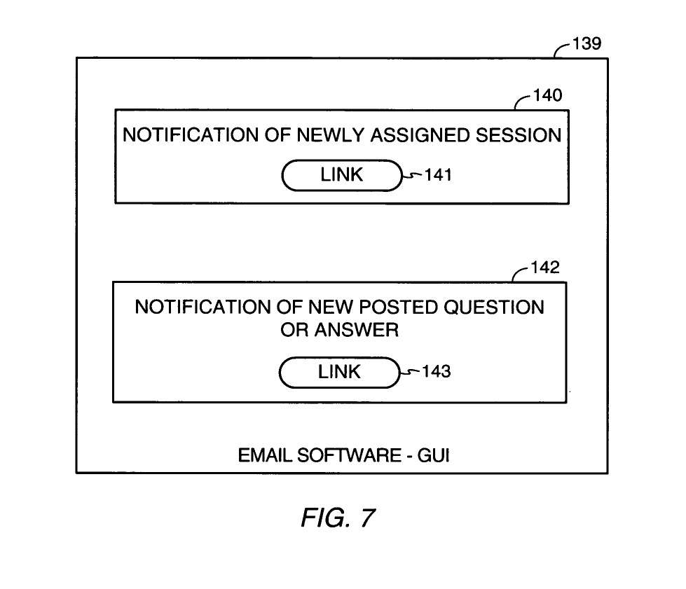

FIG. 7 schematically shows an automated email notification interface 139 having one or more emails that may be launched automatically upon the occurrence of certain conferencing session events. As shown in FIG. 7, one such automated email notification may include a Newly Assigned notification 140 communicating to the email recipient that a session has just been assigned to the email recipient. Newly Assigned notification 140 may be provided with a URL link 141, which takes the participant (the email recipient) to a profile sheet providing profile information pertaining to that session. A New Posted Q/A notification 142 may also be automatically launched to communicate to the email recipient that a question or an answer has been posted, intended for the email recipient. Notification 142 may provide information to the participant regarding a newly posted question or answer, and may also include a URL link 143, to provide the participant with access to the newly posted question or answer field using a standard web page interface.

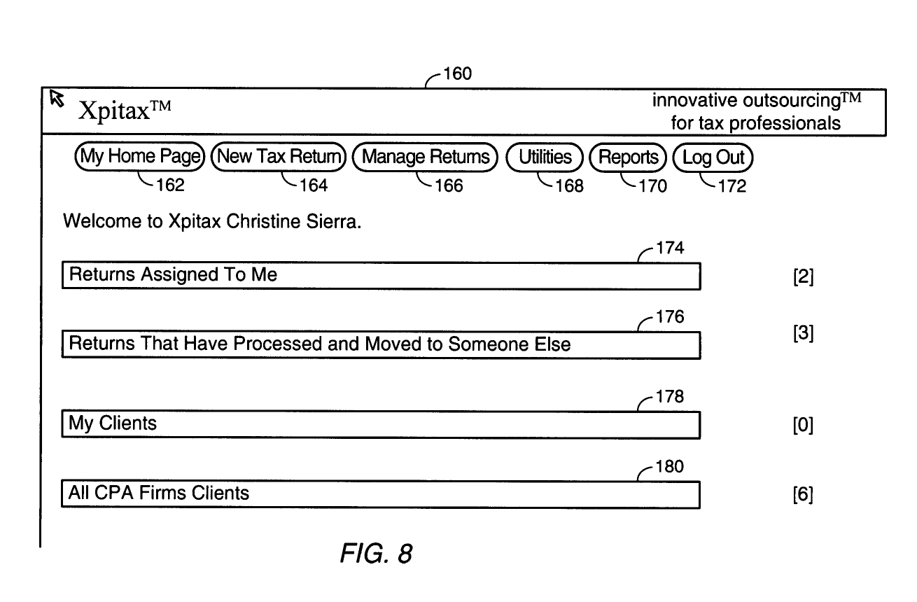

FIG. 8 is a participant screen 160 for a tax return implementation of the illustrated conferencing system. The illustrated screen 160 is one used primarily by professional staff at a CPA firm, and it includes a number of buttons for providing a participant with access to other screens. These buttons include a My Home Page button 162, a New Tax Return button 164, a Manage Returns button 166, a Utilities button 168, a Reports button 170, and a Log Out button 172. The illustrated screen 160 further includes a number of display/access graphical tools in a central portion of the screen, including a Returns Assigned To Me status bar 174, a Returns Processed and Moved To Someone Else status bar 176, a My Clients status bar 178 and an All CPA Firm Clients status bar 180.

The My Home Page button 162 takes the participant to his or her home page, which can be set to include specific information preferred by that participant. The New Tax Return button 164 takes the participant to a profile sheet screen for a new individual tax return. The Manage Returns button 166 takes the participant to a screen used to manage returns already created and in process. This Manage Returns button 166 provides access to pages primarily used by administrative staff of a CPA firm. The Utilities button 168 takes the user to a web administrator screen used to manage all CPA user accounts, log ins, and viewing options. The Utilities button 168 may not be displayed on all My Home Page screens of all users.

The Returns Assigned To Me status bar 174 provides the user with access to information about those returns that are now (i.e., contemporaneously) located with the participant. As indicated by the brackets to the right of status bar 174, two (2) tax returns have been assigned to Christine Sierra, who is the person logged on to the participant screen 160 shown in FIG. 8. Status bar 176 is provided to allow the participant access to the information about those returns that have been processed and moved to another participant. In the screen 160 shown in FIG. 8, status bar 176 will provide access to three such returns, as indicated by the number 3 in brackets to the right of that status bar. The My Clients status bar 178 provides the participant with access to information about all tax returns for the client of the participant. The All CPA Firm Clients status bar 180 provides the participant with access to all returns for all clients of the CPA Firm for which the participant works.

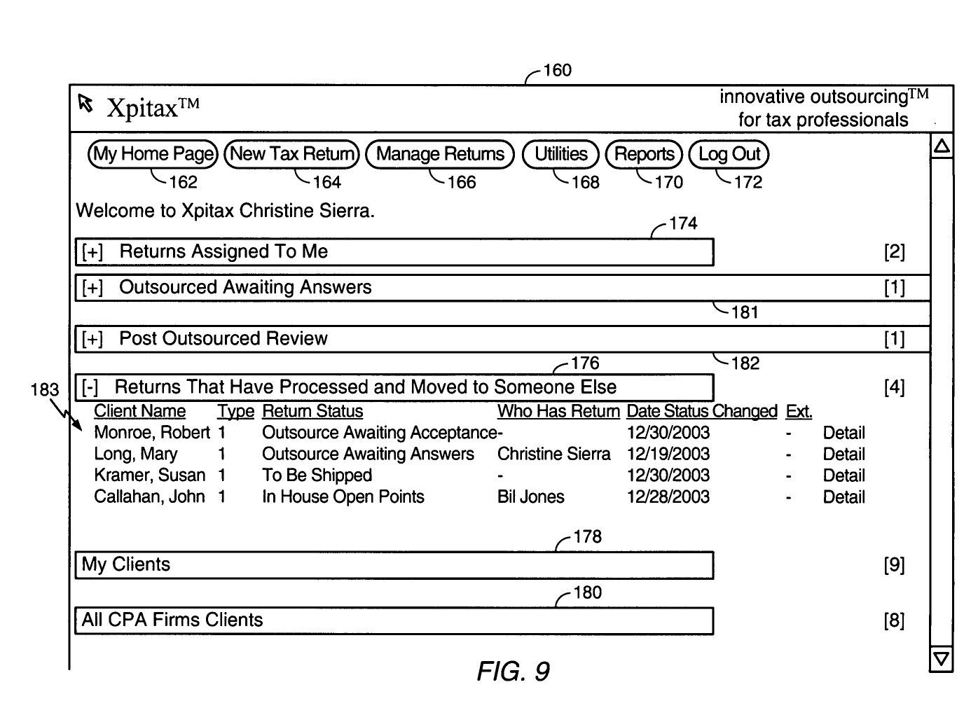

FIG. 9 is another view of the participant home page screen 160, with certain status bars expanded, thereby revealing information accessed by clicking on those status bars. The darker status bars shown in FIGS. 8 and 9 may be the color BLUE. In the specific embodiment illustrated, the BLUE status bars always appear on the screen. When there is information beneath those bars, the number count to the right will increase. Under the status bar labeled Returns Assigned To Me, gray status bars 181 and 182 may be provided to access client returns. These status bars include an Outsource Awaiting Answers status bar 181 and a Post Outsource Comp. Review status bar 182. These status bars inform the user of the current phase of tax preparation for each tax return, and also indicate the specific action required from the participant. When the user clicks on the Return Processed and Moved status bar 176, further tax return information 183 is displayed pertaining to those returns.

The following header bars can be found under the illustrated My Home Page: Returns Assigned to Me (which include all returns currently assigned to the user logged into the system); Pre Prep Completeness Review (which include those participant returns to be reviewed prior to assigning the returns to a preparer (with In House Preparation or To Be Outsourced)); In House Preparation (those participant returns to be prepared internally); Post Prep Awaiting Info (those participant returns waiting for information from a taxpayer, prior to completion); Outsource Awaiting Answers (those participant returns with questions posted by an outsourced tax preparer); In House Questions Posted (those participant returns with questions posted by an internal preparer, i.e., a preparer within the CPA Firm); In House Questions Answered (those participant returns with questions answered, returned for completion); Post Outsource Comp. Review (those participant returns which have been outsourced, to be reviewed to make sure all open items have been resolved); In House Review (those participant returns which have been prepared internally, and are to be reviewed); To Be Signed (those participant returns ready for signature); and Returns That I Have Processed And Moved To Someone Else (those returns previously assigned to the current participant logged on to the system, which are now being worked on by others).

The following header bars can be found under a Managed Returns page: Information In Not Moved (the CPA firm has received taxpayer information, created a client profile sheet and logged a return into the system; the return needs to be moved to In House Preparation, Unassigned, To Be Outsourced, or Outsourced); Unassigned (under this header bar, is taxpayer information that has been received; the return has been placed in a section for in-house preparers to come and assign the return to themselves or to another preparer); To Be Outsourced (returns to be moved to be outsourced or by an outsourced coordinator); Unassigned Awaiting Info (those returns needing additional information before being assigned to In House Preparation, Unassigned, To Be Outsourced, or Outsourced); Outsourced (returns outsourced and in process ); Outsourced Awaiting Acceptance (returns that have been completed by the outsourced team and need to be downloaded by a outsource coordinator and moved to the next process step (i.e., Post Outsource Comp Review)); To Be Assembled (those returns completed and ready to be assembled); To Be Signed (those returns assembled and ready to be signed); To Be Shipped (returns signed and ready to be shipped); To Be Extended (returns which need an extension prepared); and No Longer Client (NLC) (returns for which a profile sheet was created and the taxpayer is no longer a client, or the profile sheet was created in error; in the illustrated embodiment shown, profile sheets cannot be deleted.)

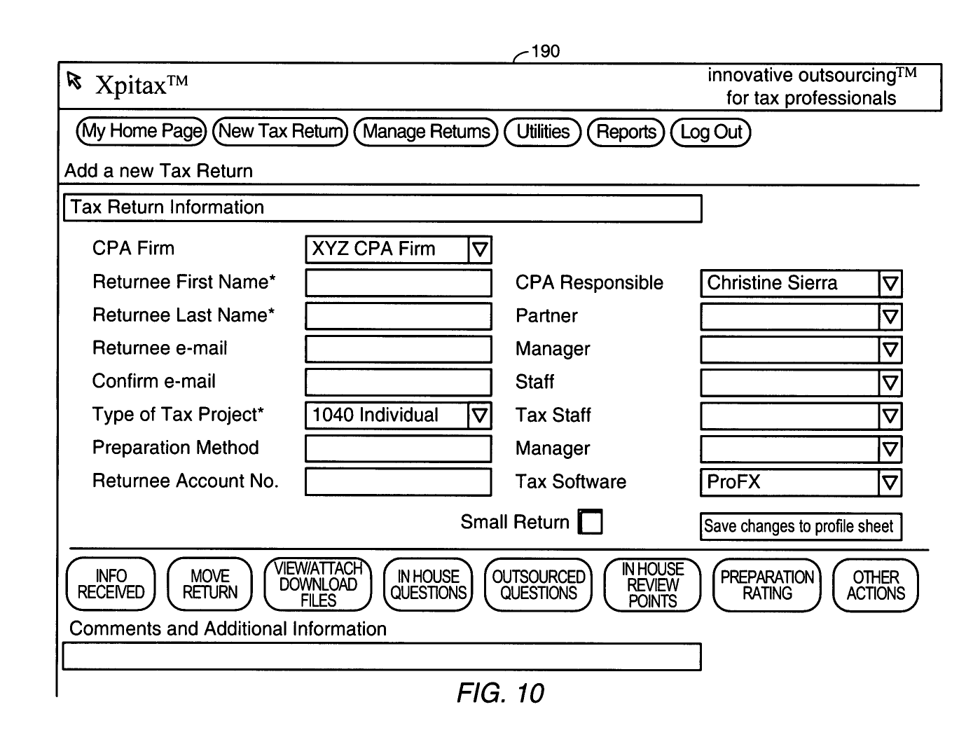

FIG. 10 shows a profile sheet screen 190 of the illustrated conferencing system. The illustrated profile sheet screen 190 includes, at the top, buttons for taking the participant, currently logged on to the conferencing system, to My Home Page, New Tax Return, Manage Returns, Utilities, Reports and Log Out screens respectively. The illustrated profile sheet screen 190 is accessed when a user selects the New Tax Return button at the top of screen.

Accordingly, in a central portion of the profile sheet screen 190, a number of displayed fields are provided, each field either displaying information that is already entered for that field or providing a blank field for inputting data for each such field. Those fields include the following: CPA Firm (the name of the CPA Firm is provided in this field; once a CPA Firm name is entered, the name in this field will remain the same as a default entry for each such field); Returnee First Name (here the first name of the returnee is entered); Returnee Last Name (here the last name of the returnee is entered); Returnee Email (here, the email for the client is entered; a tax preparer will enter this if it is in the scanned taxed documents); Confirm E-Mail (here the email address of the returnee is again entered); Type of Tax Project (a user can select from, for example, Individual, Partnership, Fiduciary, Corporation, S Corporation, Retirement, or Bookkeeping, as different types of tax projects); Preparation Method (this will populate automatically later in the process, when the return is moved to Outsourced or In House Prep); Returnee Account Number (here an internal account number may optionally be provided); CPA Responsible (the name of the person responsible for the tax return can be selected from a list or typed in at this field; this is usually a partner or manager; this person will be responsible for answering all the questions regarding this client's return); Partner (an optional field; if populated, the person listed here will see this return on his or her My Client list.); Manager (an optional field; if populated, the person listed here will see this return on his or her My Client list); Staff (an optional field; if populated, the person listed here will see the return on his or her My Client list); Tax Staff (also an optional field, if populated, the person listed here will see the return on his or her My Client list); Tax Software (tax software used to prepare the tax return may be chosen and indicated in this field); Comments and Additional Information (this field can be used to send specific instructions for a return, or to inform people of certain information pertaining to the return; the CPA Firm may choose whether or how to use this field).

A number of buttons are provided at the bottom of the profile sheet screen 190 shown in FIG. 10. Those buttons include the following: Info Received (by activating this button, the date that the taxpayer information is received may be recorded and the return can be logged in); Move Return (clicking this button takes the user to a Move Return interface, which may be used to move through the system, for example, to another participant); View/Attach/Download Files (clicking this button can take the user to a different screen where taxpayer source documents can be viewed, additional source documents can be attached, or tax data files can be downloaded once the return has been returned to the CPA Firm.); In House Questions (clicking this button takes the user to a screen where the user can prepare, respond, and review questions for returns prepared internally, by CPA Firm personnel); Outsource Questions (clicking this button can take the user to a screen to allow the user to prepare, respond, and review questions for returns prepared by the outsource team); In House Review Points (clicking this button takes the user to a screen where he or she can prepare and respond to review points for any return); Preparation Rating (clicking this button takes the user to a screen to allow user to rate a return prepared, for example, by the outsourcing team); and Other Actions (used to designate a return to be extended, or to mark a return on First Extension, on Second Extension, and/or E-Filed).

Any given My Home Page for a particular category of participant will have status bars, which can be clicked to access a list of tax returns. As shown in FIG. 9, when such a status bar is clicked, its corresponding tax returns are listed, in the illustrated embodiment, by client name, type, return status, who has the return, the date the status was changed, and other information. A given profile sheet for a given tax return can be accessed by clicking the client name in any such list. At that point, the participant will be taken to a profile sheet for that tax return which presents the information in the fields shown in FIG. 10 in the format of the profile sheet screen 190 shown in FIG. 10. Specifically, a variation of the profile sheet screen 190 shown in FIG. 10 will be presented to the participant, which will be called an Edit a Tax Return screen (not separately shown in the figures), but substantially the same as the screen shown in FIG. 10.

A return is first processed by indicating that information pertaining to the tax return has been received. This is done by clicking the Info Received button at the bottom of the profile sheet screen 190. Then, one of the personnel, for example, the CPA responsible participant indicated in the profile sheet, may select the Move Return button at the bottom of the profile sheet screen 190, which will prompt the participant with a drop down box where he or she can select the next move for this return. For outsourcing, the participant will select To Be Outsourced. If the participant is the outsource coordinator, the participant can select Outsourced. For a return to be processed in house, the participant may select In House Prep or Unassigned. If the participant moves the return directly to In House Prep, he or she will also need to select the person to whom he or she is moving the return.

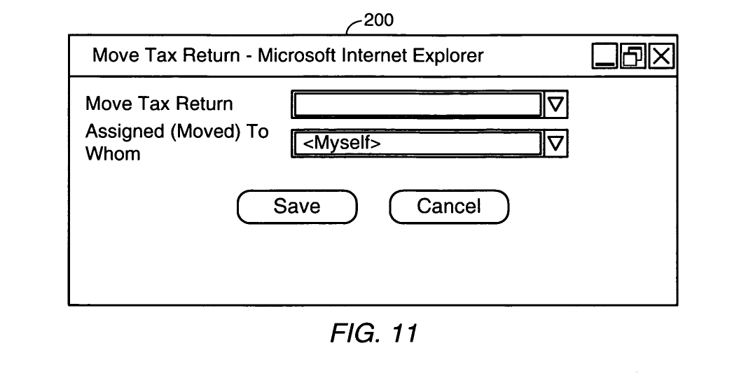

FIG. 11 shows a Move Tax Return screen 200. As shown in the illustrated Move Tax Return screen 200, a Move Tax Return drop down menu can be clicked on to show to the participant the various phases of the tax return that can be selected, including, for example, To Be Outsourced, Outsourced, In House Prep, and Unassigned. Similarly, an Assigned (moved) To Whom drop down menu can be clicked on to present to the participant a list of personnel to which the return can be moved or relocated. A given return can be moved throughout a given CPA process by selecting the Move button and moving the return through questions, review, assembly, signature, and shipping (as determined by the management of the CPA Firm).

A given return may have questions. The preparer for a return (in house or outsourced) should keep the profile sheet screen 190 or any part of the conferencing system active and running while preparing the return. When the preparer has a question, the preparer will post the question to the profile sheet by selecting either the In House Questions button or the Outsourced Question button on the bottom of the profile sheet. The preparer should type his or her questions in the questions text box in the Questions Pop-up window, and refer to the page number in the source document to which the question relates. After typing the question, the participant can select Save. Upon completing the questions, the preparer will select the Send to CPA Responsible button on the bottom of the Questions Pop-up window.

Once the preparer submits questions pertaining to a particular return, that return will appear under the Returns Assigned To Me—Awaiting Answers heading on the home page.

Once questions have been posted to the conferencing system by the preparer, an email noting the taxpayer's name is automatically sent to the tax responsible person. If the tax responsible person wants to have someone else answer the questions he can forward the email to that person. The taxpayer's profile sheet can then be accessed in the All CPA Firms section of the My Home Page of any individual who is not specifically listed as a key personnel member on the profile sheet for that return.

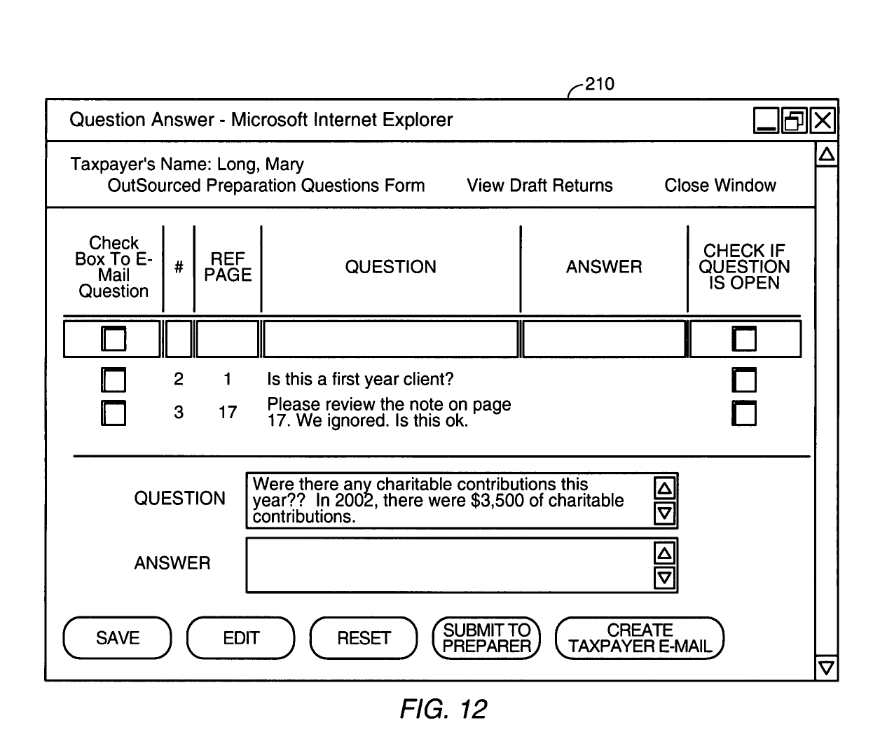

To read and respond to a question, a user can select and click the taxpayer's name under the In House or Outsourced Awaiting Answers heading. Clicking on the Questions button at the bottom of the screen and the Questions Answer box will appear. At this point, a screen as shown in FIG. 12 will be presented to the user, which shows an example questions form screen 210. As shown in FIG. 12, a questions form screen 210 includes a list of questions, with check boxes along the left corresponding to each question, which when checked will indicate that an email is to be generated and sent upon saving of a question or answer in the questions form screen 210. A field is provided to allow questions and answers to be read and typed in. By highlighting a particular question/answer set in the rows towards the top of the screen, the fields below will be populated with the text for the corresponding question and answer. The user can type into that corresponding field to add or modify a question or answer.

If the CPA needs the questions to be addressed by the taxpayer, the box to the left of question (check box to email questions) can be selected, and the Create Tax Payer Email button can be selected. An email from the user will automatically be created.

To respond to a question, the question can simply be highlighted, which will populate the Question field at the bottom of the screen. The Answer field can then be filled out and the Save button can be selected. The answer will then appear on the screen next to question, and when the user is finished he or she can select the Submit to Preparer button. The response is automatically submitted back to the preparer.

For outsourced returns, the user may view a PDF file of the partially completed return, before responding to a question by clicking on the View Draft Return heading which is towards the top of the screen.

If a user checks off the Check if Question is Open box, then the Question button will change colors indicating that the question still needs to be addressed.

The Review Points feature is similar to the Questions feature. A preparer and a reviewer open the Review Points Pop-Up window by selecting the Review Points button on the bottom of a profile sheet screen. Posting Review Points and responding to Review Points is performed by following the same process as discussed above for questions and answers.

The claims as originally presented and as they may be amended, encompass variations, alternatives, modifications, improvements, equivalents and substantial equivalents of the embodiments and teachings disclosed herein, including those that are presently unforeseen or unappreciated, and that, for example, may arise from applicants/patentees and others.

What is claimed is:

1. Computer conferencing apparatus, the computer conferencing apparatus comprising:
a conferencing session intake interface to receive, at a computer, parameters defining plural conferencing sessions;
a computer screen provider to provide, at computers, participant screens, the participant screens including a first participant screen and a second participant screen;
the first participant screen being for the first participant, providing the first participant with computer screen access to a representation of all sessions contemporaneously located with the first participant and therefore requiring action by the first participant, and the providing the first participant with computer screen access to information indicating a present phase of each of the sessions contemporaneously located with the first participant;
the second participant screen being for the second participant, providing the second participant with computer screen access to a representation of all sessions contemporaneously located with the second participant and therefore requiring action by the second participant, and providing the second participant with computer screen access to information indicating a present phase of each of the sessions contemporaneously located with the second participant;
a phase change intake interface to receive, at a computer screen interface, phase change information for a given session;
a location intake interface to receive, at a computer screen interface, location change information changing a present location of the given session from being located with one of the first and second participants to being located with another of the first and second participants.

2. The apparatus according to claim 1, wherein the first and second participant screens each include access to a designated participant display indicating participants designated for a given conferencing session.

3. The apparatus according to claim 1, wherein the conferencing session comprises a protracted conference.

4. The apparatus according to claim 1, wherein the conferencing session comprises a project information tracking data structure.

5. The apparatus according to claim 1, wherein the conferencing session comprises an activity trail tracking structure.

6. The apparatus according to claim 1, wherein the parameters defining plural conferencing sessions include client information for identifying a client for a project, information describing the types of projects to be performed on behalf of the client, and designed participants designated for each conferencing session.

7. The apparatus according to claim 1, wherein the first participant screen and the second participant screen each include access controls to limit access, respectively, to the first participant and to the second participant.

8. The apparatus according to claim 1, further comprising a query response channel to receive, via computer screen input, and to track, in query fields uniquely linked to the given session, queries from one of the participants intended for a given query recipient from among the other of the participants, and to receive, via computer screen input, and track, in a response field uniquely linked to the given session, responses from the given query recipient.

9. The apparatus according to claim 1, further comprising an email generator to generate, for the given session, a given email addressed to an entity, the email generator including an email body populator to populate the email with content derived from the query fields linked to the given session.

10. The apparatus according to claim 1, further comprising a tracing mechanism to store, for the given session, a set of data tracking each action and an identifier identifying the actor for each action.

11. The apparatus according to claim 1, wherein each of the participants has a corresponding home page displaying a corresponding list of all sessions having a location associated with the participant.

12. The apparatus according to claim 1, further comprising a notification mechanism to automatically notify a participant when an action occurs associated with a session.

13. The apparatus according to claim 12, wherein the action includes a query posted for the participant.

14. The apparatus according to claim 12, wherein the action includes a response posted for the participant.

15. The apparatus according to claim 12, wherein the action includes a session being given a location associated with the participant.

16. A computer conferencing method comprising:
receiving, at a computer, parameters defining plural conferencing sessions;
providing, at computers, participant screens, the participant screens including a first participant screen and a second participant screen;
the first participant screen being for the first participant, providing the first participant with computer screen access to a representation of all sessions contemporaneously located with the first participant and therefore requiring action by the first participant, and the providing the first participant with computer screen access to information indicating a present phase of each of the sessions contemporaneously located with the first participant;
the second participant screen being for the second participant, providing the second participant with computer screen access to a representation of all sessions contemporaneously located with the second participant and therefore requiring action by the second participant, and providing the second participant with computer screen access to information indicating a present phase of each of the sessions contemporaneously located with the second participant;
receiving, at a computer screen interface, phase change information for a given session;
receiving, at a computer screen interface, location change information changing a present location of the given session from being located with one of the first and second participants to being located with another of the first and second participants.

17. The method according to claim 16, wherein the first and second participant screens include access to a designated participant display indicating participants designated for a given conferencing session.

18. The method according to claim 16, wherein the conferencing session comprises a protracted conference.

19. The method according to claim 16, wherein the conferencing session comprises a project information tracking data structure.

20. The method according to claim 16, wherein the conferencing session comprises an activity trail tracking structure.

21. Machine-readable media encoded with data, the data when interacting with a machine causing:
reviewing, at computers, parameters defining plural conferencing sessions;
providing, at computers, participant screens;
the participant screens being for respective participants, a given one of the participant screens providing a given participant with computer screen access to a representation of all sessions contemporaneously located with the given participant and therefore requiring action by the second participant, and providing the second participant with computer screen access to information indicating a present phase of each of the sessions contemporaneously located with the given participant;
receiving, at a computer screen interface, phase change information for a given session; and
receiving, at a computer screen interface, location change information changing a present location of the given session from being located with one of the participants to being located with another of the participants.
